(19) United States
(12) Patent Application Publication
(10) Pub. No.: US 2013/0346525 A1
(43) Pub. Date: Dec. 26, 2013

(54) PRIORITIZING ELECTRONIC MESSAGES BASED ON COMMUNITY VALUES

(71) Applicant: INTERNATIONAL BUSINESS MACHINES CORPORATION, ARMONK, NY (US)

(72) Inventors: Li Chen, Cary, NC (US); David M. Stecher, Seattle, WA (US); Lin Sun, Morrisville, NC (US)

(73) Assignee: INTERNATIONAL BUSINESS MACHINES CORPORATION, ARMONK, NY (US)

(21) Appl. No.: 13/954,251

(22) Filed: Jul. 30, 2013

Related U.S. Application Data
(63) Continuation of application No. 13/533,808, filed on Jun. 26, 2012.

(51) Int. Cl. H04L 12/58

(52) U.S. Cl. CPC H04L 51/26
USPC 709/206

(57) ABSTRACT

Embodiments of the present invention provide a system, method, and program product to prioritize a plurality of electronic messages. In an exemplary embodiment, a computer receives at least one vote, from at least one first user of a plurality of user, for each of the plurality of electronic messages. The at least one vote indicates which of the plurality of user is required to respond to each of the plurality of electronic messages. In the exemplary embodiment, the computer creates a community value for each of the plurality of electronic messages based, at least in part, on the at least one vote. The computer prioritizes the plurality of electronic messages based, at least in part, on the community value. In the exemplary embodiment, the at least one vote is received from at least one of a sender or an addressee of the plurality of electronic messages.

### CROSS-REFERENCE TO RELATED APPLICATIONS

This application is a continuation of U.S. patent application Ser. No. 13/533,808 filed on Jun. 26, 2012, the entire content and disclosure of which is incorporated herein by reference.

### FIELD OF THE INVENTION

The present invention relates generally to electronic messaging, and more particularly to prioritizing electronic messages based on community values.

### BACKGROUND

Electronic messaging has been widely adopted for business-related communications. Electronic messaging technologies such as e-mail and instant messaging may enable an organization to operate globally, while remaining cohesive and coordinated. In the context of a large organization, internal electronic messaging may be a powerful tool for the rapid exchange of information among many employees and may help employees identify and access each other's expertise, as well as other sources of information.

Typically, however, as the size of an organization grows, so does the complexity of the business relationships within and external to the organization. However, in some situations, employees may not have adequate time to check and reply in a timely manner to the multitude of electronic messages that the employees receive due to a hectic work schedule or other reasons. In many situations, it is not uncommon that a large number of electronic messages accumulate within the inbox associated with an employee. Within the large number of unread electronic messages, some important information could be buried that results in the electronic message not being read and/or responded to in a timely manner.

### SUMMARY

Aspects of the present invention disclose a method, system and program product for prioritizing a plurality of electronic messages.

A system, method and program product for prioritizing a plurality of electronic messages. In an exemplary embodiment, a computer receives at least one vote, from at least one first user of a plurality of users, for each of the plurality of electronic messages. The at least one vote indicates which of the plurality of users is required to respond to each of the plurality of electronic messages. In the exemplary embodiment, the computer creates a community value for each of the plurality of electronic messages based, at least in part, on the at least one vote. The computer prioritizes the plurality of electronic messages based, at least in part, on the community value. In the exemplary embodiment, the at least one vote is received from at least one of a sender or an addressee of the plurality of electronic messages.

### BRIEF DESCRIPTION OF THE SEVERAL VIEWS OF THE DRAWINGS

FIG. 1 depicts a system for prioritizing a plurality of electronic messages according to an embodiment of the present invention.

FIG. 2 is a flow chart illustrating the steps of a program installed in a computer of FIG. 1 for prioritizing a plurality of electronic messages.

FIG. 3 is a block diagram of components of computers of FIG. 1 depicted in accordance with an illustrative embodiment.

### DETAILED DESCRIPTION

In a brief summary, an exemplary embodiment of the present invention is practiced in the context of a graphical electronic messaging client running on a computing device, where the exemplary embodiment of the present invention is integrated with an existing electronic messaging system and client. A sender creates an electronic message, including naming addressees and entering text into the body of the message. As the sender composes the electronic message, or upon clicking the “Send” button or another form of selectable user interface, the computing device displays a graphical user interface viewable to the sender. The sender may select or input a vote within the graphical user interface that corresponds to whether or not each of the addressees are desired to respond to the electronic message.

Once an addressee opens the electronic message using a graphical email messaging client running on a compute device, an exemplary embodiment of the present invention may be integrated with an existing electronic messaging system and client to provide the addressee the option to vote as to whether or not other addressees are desired to respond to the electronic message. The one or more votes of the addressees may be used in conjunction with other weighing factors to prioritize the electronic messages of each user.

Known email system has been enhanced in many ways to make the use of email more convenient and efficient. For example, people may deliver their messages with different priorities (High, Normal and Low). People may create different rules to store the incoming email messages in different folders. The email messages may be classified and prioritized based on email content, user defined static configuration or calendar based information. All of the available known email systems do help the users to prioritize the email messages and decide which email messages they need read first. However, if the users have very limited time to reply to all of the high priority email messages and may only reply to a couple of the email messages, the users still have a hard time knowing which email messages to respond to first. This situation could often happen to the company executives and the architects who are in charge of several important projects. It also often happens to the email senders who fail to receive or do not receive timely feedback about the questions in cases where the recipients of the email expect other recipients in the distribution list to respond to the problem listed in the email of the sender. The sender has to send another round of follow up emails.

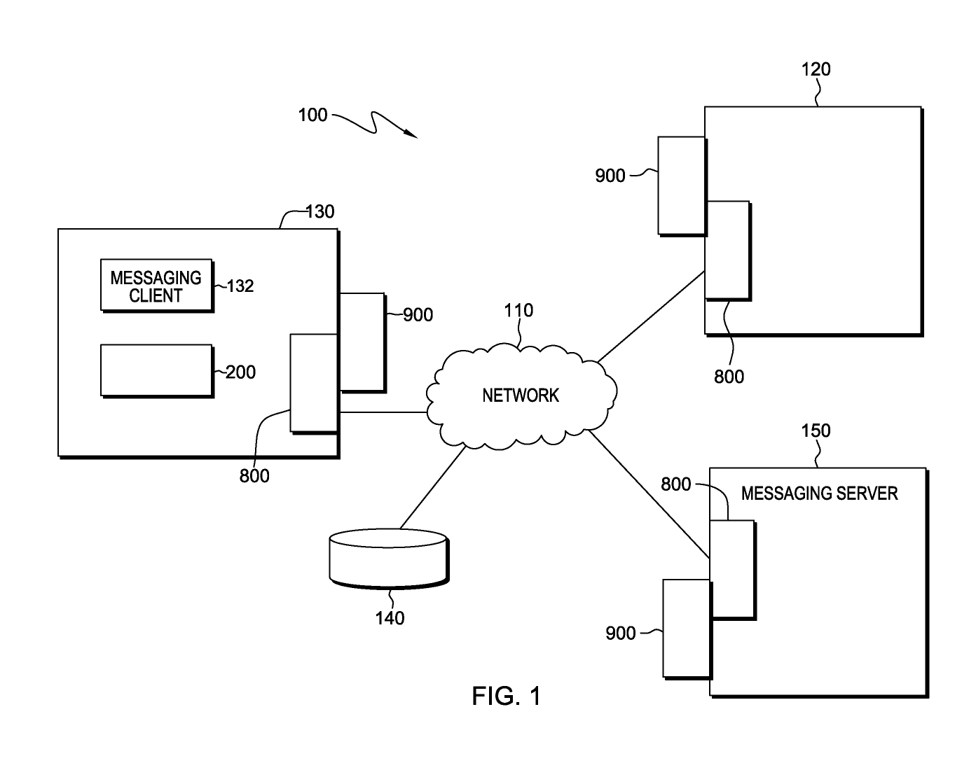

Embodiments of the present invention will now be described in detail with reference to the accompanying drawings. FIG. 1 illustrates a message prioritizing system, generally designated 100, according with an embodiment of the present invention.

Message prioritizing system 100 includes a server computer 120, a client computer 130, a network storage device 140, and a messaging server computer 150, all interconnected over a network 110. Client computer 130 includes a messaging client 132 for managing electronic messages and a message prioritizing program 200 for prioritizing a plurality of electronic messages on messaging client 132 with data retrieved from storage device 140 via network 110, and displaying and receiving votes from the user, before the electronic messages are transmitted to messaging server 150 via network 110, for delivery to addressees.

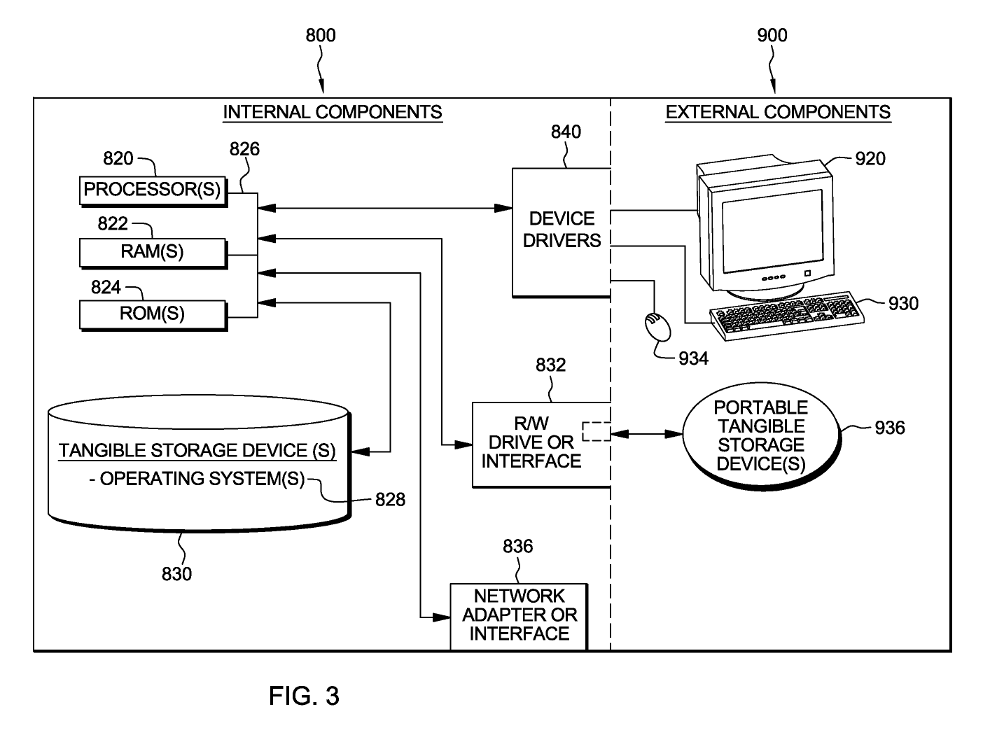

Sever computer 120, client computer 130, and messaging server 150 may be, for example, a notebook, a laptop computer, a tablet computer, a handheld device or smart-phone, a thin client, a management server, a web server, or any other electronic device or computing system capable of communicating through network 110. Server computer 120, client computer 130, and messaging server 150 include internal components 800 and external components 900. In general, server computer 120, client computer 130, and messaging server 150 may be any programmable electronic devices as described in further detail with regard to FIG. 3. In another embodiment, server computer 120, client computer 130 and/or messaging server 150 represent a “cloud” of computers interconnected by one or more networks, where server computer 120, client computer 130 and/or messaging server 150 is a primary server for a computer system utilizing clustered computers and components to act as a single pool of seamless resources when accessed through network 110. For example, this implementation may be preferred for data centers and for cloud computing applications. Further, it should be understood that, for the purpose of illustration, FIG. 1 does not show other computer systems and elements which may be present when using an embodiment of the present invention, such as, for example, additional computer systems in communication with messaging server 150 used by message recipients to receive messages.

In the depicted example, network 110 is the Internet representing a worldwide collection of networks and gateways that use the Transmission Control Protocol/Internet Protocol suite of protocols to communicate with one another. In other examples, network 110 may also be implemented as a number of different types of networks, such as, but not limited to an intranet, a local area network (LAN), or a wide area network (WAN). Examples of network 110 include wire cables, wireless communication links, fiber optic cables, routers, switches, and/or firewalls. Generally, network 110 may be any combination of connections and protocols that will support communications between server computer 120, client computer 130, and messaging server 150 in accordance with an exemplary embodiment of the invention.

In some examples, storage device 140 includes data relating to weighing factors, along with one or more votes relating to a community value for each user. Upon receiving more data relating to the weighting factors and/or more votes relating to the community value for each user, via client computer 130, the data is stored within storage device 140. Any form of storage device 140 may be used, either internal and/or external to the computers and/or network 110.

Server computer 120 executes voting program 200 for obtaining ranking information from one or more users. In an example, a sender creates an electronic message utilizing messaging client 132. As the user composes the electronic message, or upon clicking a selectable element, the messaging client 132 allows the user, through a user interface, to vote whether the addressees are required to reply to the electronic message. The user selects the addressees who are required to reply to the electronic message by selecting a selectable element in the user interface. In some examples, the user may select a date and/or time by which the addressees are required to reply to the electronic message by selecting a selectable element in the user interface.

In an example, messaging client 132 receives text inputted by a user creating an electronic message, including one or more addressees and other content of the electronic message. Typically, messaging client 132 is one or more software computer programs that are capable of being integrated with the remainder of message prioritizing system 100.

In the example, messaging server 150 receives the outputted electronic messages of client computer 130 via network 110 and delivers the messages to one or more addressees. In this example, messaging server 150 is an existing messaging system. In an example, client computer 130 is in communication with a plurality of messaging servers 150 and/or server computers 120 to enable message prioritizing system 100 to simultaneously support a plurality of electronic messaging technologies, such as, for example, e-mail, instant messaging, cellular network text messaging, blog posting, and social media messaging.

In an example, messaging client 132 receives text inputted by a sender creating an electronic message, including one or more addressees and other content of the electronic message. In this example, messaging client 132 is one or more software computer programs that are capable of being integrated with the remainder of the messaging prioritizing system 100, and which allow the sender and/or the addressees to create and view an electronic message, and transmit the electronic message to the messaging server 150. In an example, the sender enters text and any other content into an electronic message form generated by messaging client 132, such as, for example, an email message form containing “To:”, “Cc:”, “Bcc:”, “Subject:”, and message body fields. In an example, the email message form includes, at least a “Send” selectable element and a “Vote” selectable element, which the sender my select. Exemplary embodiments of the present invention may also include multiple separate or integrated messaging clients 132, and may support a plurality of electronic messaging technologies, such as, for example, email, instant messaging, cellular network text messaging, blog posting, and social media messaging.

Message prioritizing system 100 associated with the email client may perform a plurality of tasks including extracting votes associated with outgoing messages and providing the messages to server computer 120. The votes may be utilized for determining a community value associated with an addressee so that subsequent electronic messages sent to the addressee will utilize the determined community value. Messaging prioritizing system 100 may be configured as a plug-in that may be installed to work cooperatively with email client, such as to provide an integrated interface the conforms with the native interface of the email client.

Analysis of email may be performed by aggregating the emails from all the email clients associated to server computer 120. Message prioritizing program 200 may execute algorithms and/or sets of rules for ranking the electronic messages received from all email clients. The rank may be in the form of a score, an attribute, a numeric value, or some other type or parameter or meta-data. These scores may be assigned for each user for a definite period of time. The period of time may be a day, a week, a month, or some other length of time period. In addition, these scores may change over time according to a factor that reduces the length over time, and is predefined, user defined, automatically determined, etc.

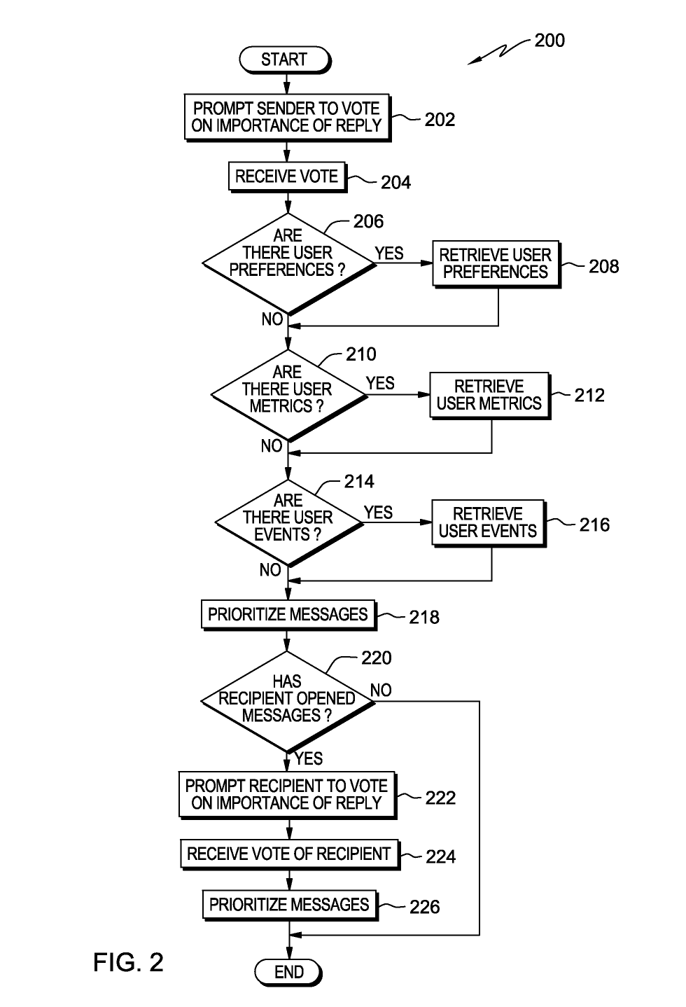

FIG. 2 is a flowchart illustrating the basic operational steps of messaging prioritizing program 200 in accordance with an exemplary embodiment of the present invention. In step 202, message prioritizing program 200 prompts the sender with the option to vote as to whether or not there is importance that the addressees are desired to respond to the electronic message. In an exemplary embodiment, the messaging prioritizing program 200 prompts the sender to vote after the sender selects a “Send” selectable element on the email message form into which the sender previously entered text. In other embodiments, the sender may not be prompted by message prioritizing program 200. In one embodiment, the sender may also select a “Vote” selectable element to initiate message prioritizing program 200 to prompt the sender with the option to vote as to whether or not the addressees are desired to respond to the electronic message. In another embodiment, message prioritizing program 200 prompts the sender with the option to vote after the sender inputs each addressee within the “To:” portion of the email message form.

In step 204, message prioritizing program 200 receives one or more votes from sender. The one or more votes are associated with the desire of the sender for the addressee to respond to the electronic message. In an exemplary embodiment, the one or more votes associated with each addressee are stored in storage device 140 in association with the electronic message account associated with each addressee. The storage device may contain a plurality of votes created by a plurality of senders and/or addresses who might send and/or receive the electronic messages.

Message prioritizing program 200 determines if there are user preferences for an electronic message account associated with a user (e.g., sender and/or an addressee) (decision block 206). In an exemplary embodiment, message prioritizing program determines if there are user preferences stored in storage device 140 for the electronic message account associated with the user.

Many different types of user preferences may be stored in storage device 140 and accessed by message prioritizing program 200, such as, for example, a weight value for each of the groups associated with a user. In one example, the user may have a higher weight value associated to a group of the managers of the user, as opposed to the weight value associated to a group of the friends of the user. In another example, the direct work team members may have the highest weight and the hobby club members may have the lowest weight. In another example, the user may have a higher weight associated with the electronic messages associated to calendar events scheduled closer in time to the present time, than calendar events scheduled at a later date and time. In another example, the user may store user preferences associated with the amount of time the user desires to spend replying to electronic messages for a normal business day and/or a busy business day. In another example, the user may set a desired time to check electronic messages. In this example, the user may only desire to access electronic messages for one hour between 8 AM and 9 AM, etc. In some examples, the user may also manually set how often and the order to reply to electronic messages. In other examples, other types of user preferences may be stored within storage device 140 that may be accessed by message prioritizing program 200 to prioritize the electronic messages of a user.

If message prioritizing program 200 determines that there are user preferences for an electronic message account associated with a user (positive branch of 206), message prioritizing program 200 retrieves the user preferences for the electronic message account associated with a user (step 208). In an exemplary embodiment, message prioritizing program 200 retrieves the user preferences from storage device 140.

If message prioritizing program 200 determines that there are not user preferences for an electronic message account associated with a user (negative branch of 206), message prioritizing program 200 determines if there are user metrics for an electronic message account associated with a user (e.g., sender and/or an addressee) (decision block 210). In an exemplary embodiment, message prioritizing program determines if there are user metrics stored in storage device 140 for the electronic message account associated with the user.

Many different types of user metrics may be stored in storage device 140 and accessed by message prioritizing program 200, such as, for example, how much time in a day that the user has access to the electronic message account associated to the user to read and reply to the electronic messages. In another example, the user metrics may include the usage pattern that the user utilizes the electronic message account associated with the user. In this example, if the user deviates from a normal email usage pattern that is stored in the user metrics associated with the electronic message account, the message prioritizing program 200 may change how the messages are prioritized.

If message prioritizing program 200 determines that there are user metrics for an electronic message account associated with a user (positive branch of 210), message prioritizing program 200 retrieves the user metrics for the electronic message account associated with a user (step 212). In an exemplary embodiment, message prioritizing program 200 retrieves the user metrics from storage device 140.

If message prioritizing program 200 determines that there are not user metrics for an electronic message account associated with a user (negative branch of 210), message prioritizing program 200 determines if there are user events for an electronic message account associated with a user (e.g., sender and/or an addressee) (decision block 214). In an exemplary embodiment, message prioritizing program 200 determines if there are user events stored in storage device 140 for the electronic message account associated with the user.

Many different types of user events may be stored in storage device 140 and accessed by message prioritizing program 200. In exemplary embodiments, the user events may be unexpected events that arise that are associated with the user that require the daily schedule of the user to be adjusted. In one example, the user may be tending to the care of a sick family member and unable to access the electronic message account associated with the user. In another example, the user may be stuck in traffic and unable to access the electronic message account associate with the user because it is illegal to use an electronic device while driving. In exemplary embodiments, the user events may be stored in storage device 140 responsive to input from the user. However, in other embodiments, the user events may be automatically stored in storage device 140 and responsive to events that occur to electronic devices associated with the user. In one example, a mobile phone associated with the user may determine that the mobile phone is moving over a predetermined rate of speed that correlates to the user operating a motor vehicle. The user event is automatically recorded in storage device 140 to be accessed later when the message prioritizing program 200 prioritizes the electronic messages associated with the user.

If message prioritizing program 200 determines that there are user events for an electronic message account associated with a user (positive branch of 214), message prioritizing program 200 retrieves the user events for the electronic message account associated with a user (step 216). In an exemplary embodiment, message prioritizing program 200 retrieves the user events from storage device 140.

If message prioritizing program 200 determines that there are not user events for an electronic message account associated with a user (negative branch of 214), or after the message prioritizing program 200 retrieves the user events for the electronic message account associated with the user, message prioritizing program 200 moves to step 218.

In step 218, message prioritizing program 200 creates a community value for each of the plurality of electronic messages associated with the electronic message account associated with the user based, at least in part, on the at least one vote. Message prioritizing program 200 prioritizes the plurality of electronic messages associated with the electronic message account associated with the user based, at least in part, on the community value. In the simplest example, message prioritizing program 200 creates the community value for each of the plurality of electronic messages associated with the electronic message account associated with the user based only on the one or more votes received from the sender of each electronic message. In another example, message prioritizing program 200 creates the community value for each of the plurality of electronic messages associated with the electronic message account associated with the user based on the one or more votes received from the sender of each electronic message, the user preferences associated with the electronic message account, the user metrics associated with the electronic message account, and the user events associated with the electronic message account. In another example, the one or more votes of the sender associated with the desire of the addressees to respond to the electronic message may be used in conjunction with other weighing factors to prioritize the electronic messages associated with the electronic message account of each user. In one example, message prioritizing program 200 only prioritizes a first electronic message in which the user should reply, because the user only has ten minutes of available time to reply to electronic messages at a given time.

Message prioritizing program 200 determines if one or more addressees opened the electronic messages within the electronic message account associated with the user (decision block 220). If message prioritizing program 200 determines that one or more addressees has not opened the electronic messages within the electronic message account associated with the user (negative branch of 220), message prioritizing program does not prioritize the electronic messages again. If message prioritizing program 200 determines that one or more addressees has opened the electronic messages within the electronic message account associated with the user (positive branch of 220), message prioritizing program 200 prompts the addressee with the option to vote as to whether or not the other addressees are desired to respond to the electronic message (step 222). In an exemplary embodiment, the messaging prioritizing program 200 prompts the addressee to vote after the addressee selects a “Reply” selectable element on the email message form into which the addressee enters text. In other embodiments, the addressee may not be prompted by message prioritizing program 200. In one embodiment, the addressee may also select a “Vote” selectable element to initiate message prioritizing program 200 to prompt the addressee with the option to vote as to whether or not the other addressees are desired to respond to the electronic message.

In step 224, message prioritizing program 200 receives one or more votes from the addressee that has opened the electronic message to view. The one or more votes are associated with the desire of the sender for the other addressee(s) to respond to the electronic message. In an exemplary embodiment, the one or more votes associated with each addressee are stored in storage device 140 in association with the electronic message account associated with each addressee. The storage device may contain a plurality of votes created by a plurality of senders and/or addresses who might send and/or receive the electronic messages.

In step 226, message prioritizing program 200 creates a community value for each of the plurality of electronic messages associated with the electronic message account associated with the user based, at least in part, on the at least one vote. Message prioritizing program 200 prioritizes the plurality of electronic messages associated with the electronic message account associated with the user based, at least in part, on the community value. In the simplest example, message prioritizing program 200 creates the community value for each of the plurality of electronic messages associated with the electronic message account associated with the user based only on the one or more votes received from the sender of each electronic message. In another example, message prioritizing program 200 creates the community value for each of the plurality of electronic messages associated with the electronic message account associated with the user based on the one or more votes received from the sender of each electronic message, the user preferences associated with the electronic message account, the user metrics associated with the electronic message account, and the user events associated with the electronic message account. In another example, the one or more votes of the sender associated with the desire of the addressees to respond to the electronic message may be used in conjunction with other weighing factors to prioritize the electronic messages associated with the electronic message account of each user. In one example, message prioritizing program 200 only prioritizes a first electronic message in which the user should reply, because the user only has ten minutes of available time to reply to electronic messages at a given time.

Operational steps 202 through 226 are illustrative of one or more embodiments of the present invention. It should be understood that the content of each step, as well as the order of operation, may be modified without departing from the spirit and intended scope of the present invention.

FIG. 3 shows a block diagram of internal components 800 and external components 900 of server computer 120, client computer 130, and messaging server 150 in accordance with an illustrative embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

Computer system 800, 900 is representative of any electronic device capable of executing machine-readable program instructions. Computer system 800, 900 may be representative of a smart phone, a computer system, PDA, or other electronic devices. Examples of computing systems, environments, and/or configurations that may represented by computer system 800, 900 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

Server computer 120, client computer 130 and messaging server 150 include respective sets of internal components 800 and external components 900 illustrated in FIG. 3. Each of the sets of internal components 800 includes one or more processors 820, one or more computer-readable RAMs 822 and one or more computer-readable ROMs 824 on one or more buses 826, one or more operating systems 828, and one or more computer-readable tangible storage devices 830. The one or more operating systems 828 and programs 132 and 200 in client computer 130, as well as any necessary operating systems and other software in server computer 120 and messaging server 150, are stored on one or more of the respective computer-readable tangible storage devices 830 for execution by one or more of the respective processors 820 via one or more of the respective RAMs 822 (which typically include cache memory). In the embodiment illustrated in FIG. 3, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that may store a computer program and digital information.

Each set of internal components 800 also includes a R/W drive or interface 832 to read from and write to one or more portable computer-readable tangible storage devices 936 such as a CD-ROM, DVD, memory stick, magnetic tape, magnetic disk, optical disk or semiconductor storage device. The programs 132 and 200 in client computer 130, as well as any necessary software in server computer 120 and messaging server 150 may be stored on one or more of the respective portable computer-readable tangible storage devices 936, read via the respective R/W drive or interface 832 and loaded into the respective hard drive 830.

Each set of internal components 800 also includes one or more network adapters or interfaces 836 such as a TCP/IP adapter cards, wireless Wi-Fi interface cards, or 3G or 4G wireless interface cards or other wired or wireless communication links. The programs 132 and 200 in client computer 130, as well as any necessary software in server computer 120 and messaging server 150 may be downloaded to the respective computer systems from an external computer via a network (for example, the Internet, a local area network or other, wide area network) and respective network adapters or interfaces 836. From the one or more network adapters or interfaces 836, programs 132 and 200 in client computer 130, as well as any necessary software in server computer 120 and messaging server 150, are loaded into the respective hard drive 830. The network may comprise copper wires, optical fibers, wireless transmission, routers, firewalls, switches, gateway computers and/or edge servers.

Each of the sets of external components 900 may include a computer display monitor 920, a keyboard 930, and a computer mouse 934. External components 900 may also include touch screens, virtual keyboards, touch pads, pointing devices, and other human interface devices. Each of the sets of internal components 800 also includes device drivers 840 to interface to computer display monitor 920, keyboard 930 and computer mouse 934. The device drivers 840, R/W drive or interface 832, and one or more network adapters or interfaces 836 comprise hardware and software (stored in storage device 830 and/or ROM 824).

Aspects of the present invention have been described with respect to block diagrams and/or flowchart illustrations of methods, apparatus (system), and computer program products according to embodiments of the invention. It will be understood that each block of the flowchart illustrations and/or block diagrams, and combinations of blocks in the flowchart illustrations and/or block diagrams, may be implemented by computer instructions. These computer instructions may be provided to a processor of a general purpose computer, special purpose computer, or other programmable data processing apparatus to produce a machine, such that instructions, which execute via the processor of the computer or other programmable data processing apparatus, create means for implementing the functions/acts specified in the flowchart and/or block diagram block or blocks.

The aforementioned programs may be written in any combination of one or more programming languages, including low-level, high-level, object-oriented or non object-oriented languages, such as Java, Smalltalk, C, and C++. The program code may execute entirely on the user's computer, partly on the user's computer, as a stand-alone software package, partly on the user's computer and partly on a remote computer, or entirely on a remote computer or server. In the latter scenario, the remote computer may be connected to the user's computer through any type of network, including a local area network (LAN) or a wide area network (WAN), or the connection may be made to an external computer (for example, through the Internet using an Internet service provider). Alternatively, the functions of the aforementioned programs may be implemented in whole or in part by computer circuits and other hardware (not shown).

The foregoing description of various embodiments of the present invention has been presented for purposes of illustration and description. It is not intended to be exhaustive nor to limit the invention to the precise forms disclosed. Many modifications and variations are possible. Such modifications and variations that may be apparent to a person skilled in the art of the invention are intended to be included within the scope of the invention as defined by the accompanying claims.

What is claimed is:

1. A method of prioritizing a plurality of electronic messages, comprising:
receiving at least one vote, from at least one first user of a plurality of users, for each of the plurality of electronic messages wherein (i) the at least one vote indicates which of the plurality of users is required to respond to each of the plurality of electronic messages and (ii) the at least one vote is received from at least one of a sender or an addressee of the plurality of electronic messages;
creating a community value for each of the plurality of electronic messages based, at least in part, on the at least one vote; and
prioritizing the plurality of electronic messages based, at least in part, on the community value;
wherein at least one of the steps is carried out using a computing device.

2. The method according to claim 1 further comprising receiving a weight from a second user;
wherein the community value is further based on the weight from a second user.

3. The method according to claim 2 wherein the weight is based on a social distance between two of the plurality of users.

4. The method according to claim 1 wherein the prioritizing is further based on at least in part a time duration to check electronic messages.

5. The method according to claim 4 further comprising the step of prioritizing the plurality of electronic messages based on a predetermined user setting.

6. The method of claim 1, wherein the electronic message is selected from the group consisting of an email, an instant message, a MMS, and a SMS.
